(19) United States
(12) Patent Application Publication
(10) Pub. No.: US 2013/0119288 A1
(43) Pub. Date: May 16, 2013

(54) GATE SHEAR VALVE

(71) Applicant: Michael Shaw, Aberdeen (UK)

(72) Inventor: Michael Shaw, Aberdeen (UK)

(73) Assignee: VETCO GRAY INC., Houston, TX (US)

(21) Appl. No.: 13/297,403

(22) Filed: Nov. 16, 2011

(51) Int. Cl. F16K 3/30

(52) U.S. Cl. 251/328

(57) ABSTRACT

A gate valve capable of shearing through any downhole tooling and maintaining its seal capability after the shearing operation is complete. The gate valve has a body with a flow passage therein and a gate being linearly movable between a closed position blocking flow through the flow passage and an open position. First and second valve seats are mounted on opposite sides of the gate and have sealing surfaces that engage the gate when the gate is in the closed position. Shear elements are connected to and carried by each of the valve seats and are capable of axial movement relative to the valve seats in response to movement of the gate from the open position to the closed position.

### FIELD OF THE INVENTION

This technique relates in general to gate valves, and in particular to a gate valve having shearing surfaces independent and apart from sealing surfaces to maintain post-shear seal integrity.

### BACKGROUND OF THE INVENTION

A production bore intervention valve may be used on a subsea oil and gas work over riser system. The work over riser system provides safe access to the production bore during well intervention activities. The intervention valve provides a means to control well bore fluids and also to allow the platform to disconnect from the well during an emergency situation. Closure of the valve may be required when downhole tooling such as coiled tubing or wireline are still running through the valve such that the valve must be capable of severing these tools to allow the valve to close, while maintaining its function as a fluid barrier.

The action of shearing any downhole tooling requires significant loads and very high localized stresses on the gates and seats involved. This stressing can lead to damage or general degradation of the surface finish on any of the sealing faces of the gates and seats adjacent to the edges where this shearing occurs. The sheared downhole tooling, particularly the plug of tooling that becomes trapped in the through hole of the gate, can also cause surface damage as its cut faces are dragged across the sealing faces of the seats as the valve travels to the fully closed position. This surface damage to the sealing faces of the gate and the seat can cause sealing problems when the valve is closed, leading to leakage.

A need exists for a technique that eliminates or reduces damage and general degradation of the surface finish of any sealing faces of the gates and to the seats adjacent to the edges where shearing occurs. The following technique may solve one or more of these problems.

### SUMMARY OF THE INVENTION

In an embodiment of the present technique, a gate valve has a valve body with a flow passage and a central chamber therein. A gate has a hole therein, and is linearly movable within the chamber between a closed position blocking flow through the flow passage and an open position in which the hole registers with the flow passage. First and second valve seats are mounted in the chamber on opposite sides of the gate at the intersection of the flow passage with the central chamber. The valve seats have sealing surfaces that engage the gate when the gate is in the closed position. A shear element is connected to and carried by at least one of the valve seats. The shear element is capable of movement relative to the at least one of the valve seats in response to movement of the gate from the open position to the closed position.

In an embodiment of the present technique, a gate valve has a valve body with a flow passage and a central chamber therein. A gate has a hole therein, and is linearly movable within the chamber between a closed position blocking flow through the flow passage and an open position in which the hole registers with the flow passage. First and second valve seats are mounted in the chamber on opposite sides of the gate at intersections of the flow passage with the central chamber. The valve seats have sealing surfaces that engage the gate when the gate is in the closed position. A shear element is a partial segment of a circle connected to and carried by each of the valve seats. The shear elements protrude beyond the sealing surfaces of the valve seats in an extended position when the gate is in the closed position. The shear elements are capable of axial movement relative to an axis of the hole in gate to a retracted position in response to movement of the gate from the open position to the closed position.

In an embodiment of a method of the present technique, a gate is mounted within a valve body having valve seats, a central chamber, and a flow passage extending therefrom. The gate has a hole therein, and a shear element is mounted to at least one of the valve seats with the shear element in an extended position. The gate is moved from an open position toward a closed position, which causes the shear element to move to a retracted position. The gate is engaged with the valve seats, thereby sealing the flow passage.

### BRIEF DESCRIPTION OF THE DRAWINGS

So that the manner in which the features and benefits of the technique, as well as others which will become apparent, may be understood in more detail, a more particular description of the technique briefly summarized above may be had by reference to the embodiments thereof which are illustrated in the appended drawings, which form a part of this specification. It is also to be noted, however, that the drawings illustrate only various embodiments of the technique and are therefore not to be considered limiting of the technique's scope as it may include other effective embodiments as well.

FIG. 1 is a sectional view illustrating a gate valve that has features constructed in accordance with this technique in an open position.

FIG. 2 is an enlarged view of the gate and seat portion of FIG. 1, showing the gate in an open position.

FIG. 3 is a sectional view illustrating a gate valve that has features constructed in accordance with this technique in a closed position.

FIG. 4 is an enlarged view of the gate and seat portion of FIG. 3, showing the gate in a closed position.

FIG. 5 is a perspective view of the valve seat and shear element of the gate valve of FIG. 1.

FIG. 6 is a perspective view of the gate of the gate valve of FIG. 1.

FIG. 7 is an enlarged view of the gate valve of FIG. 1, showing the gate in an open position and one embodiment of how the shear elements are retained.

FIG. 8 is an enlarged view of the gate valve as shown in FIG. 7, showing the gate in a closed position.

FIG. 9 is an enlarged view of the gate valve of FIG. 1, showing the gate in an open position and a second embodiment of how the shear elements are retained.

FIG. 10 is an enlarged view of the gate valve as shown in FIG. 9, showing the gate in a closed position.

### DETAILED DESCRIPTION OF THE INVENTION

The present technique now will be described more fully hereinafter with reference to the accompanying drawings in which a preferred embodiment of the technique is shown. This technique may, however, be embodied in many different forms and should not be construed as limited to the embodiment set forth herein; rather, this embodiment is provided so that this disclosure will be thorough and complete, and will fully convey the scope of the technique to those skilled in the art. Like numbers refer to like elements throughout.

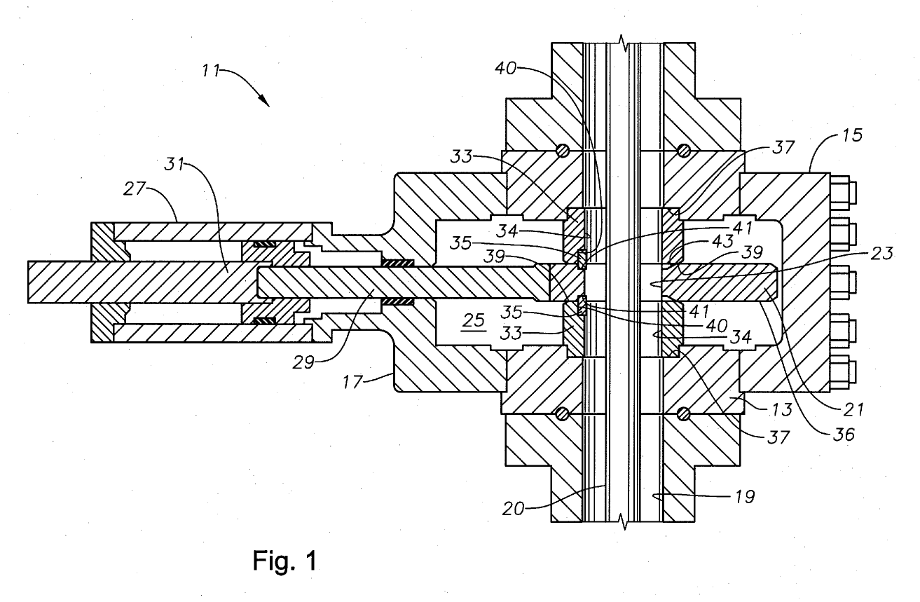

Referring to FIG. 1, a valve 11 is a standard gate valve except for features in accordance with this invention. The valve 11 has a body 13, a base 15, a bonnet 17, and a flow passage 19 that extends transversely through the body 13. As illustrated, coiled tubing 20, or in other embodiments, wire line, may extend through the flow passage 19. The valve 11 has a gate 21 with a hole 23 therethrough. The gate 21 is located in a sealed chamber 25 in the body 13 and is shown in the open position in FIG. 1. The gate 21 is connected to an actuation device 27 by a stem 29 that extends between the gate 21 and the actuation device 27. In this embodiment, the actuation device 27 is an actuator piston 31 that connects to the stem 29 to stroke the gate 21 between its open and closed positions. Also shown in FIG. 1 are ring-shaped valve seats 33 mounted in the body 13, which have holes 34 that register with the flow passage 19 of the valve 11. Each valve seat 33 is fitted with a shear element 35. In an embodiment, each shear element 35 may be either a complete circumferential ring or a partial section thereof. In other embodiments, the shear element 35 may have other shapes, for example, the shear element 35 may be rectangular or may have a variable cross section. In the embodiments illustrated, shear element 35 is a partial section of a ring. The shear elements 35 may be either releasably or movably connected to the valve seats 33.

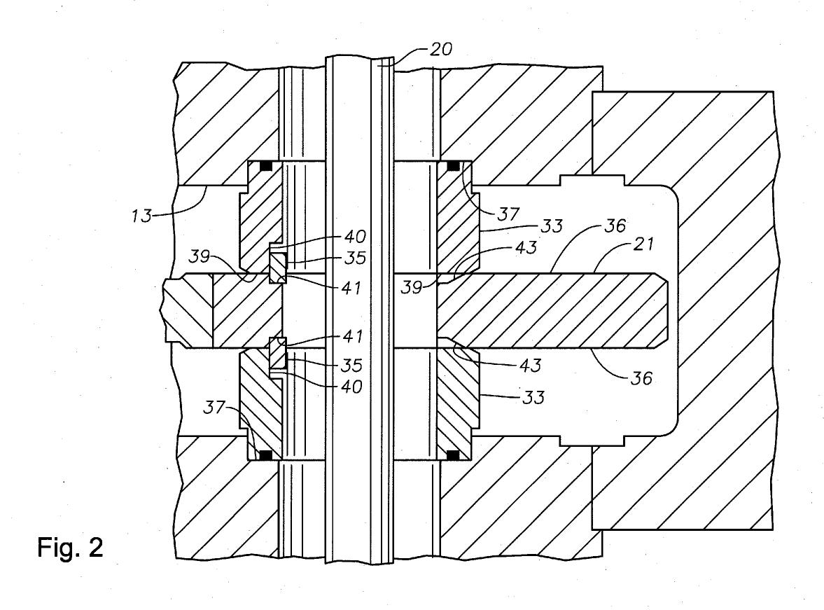

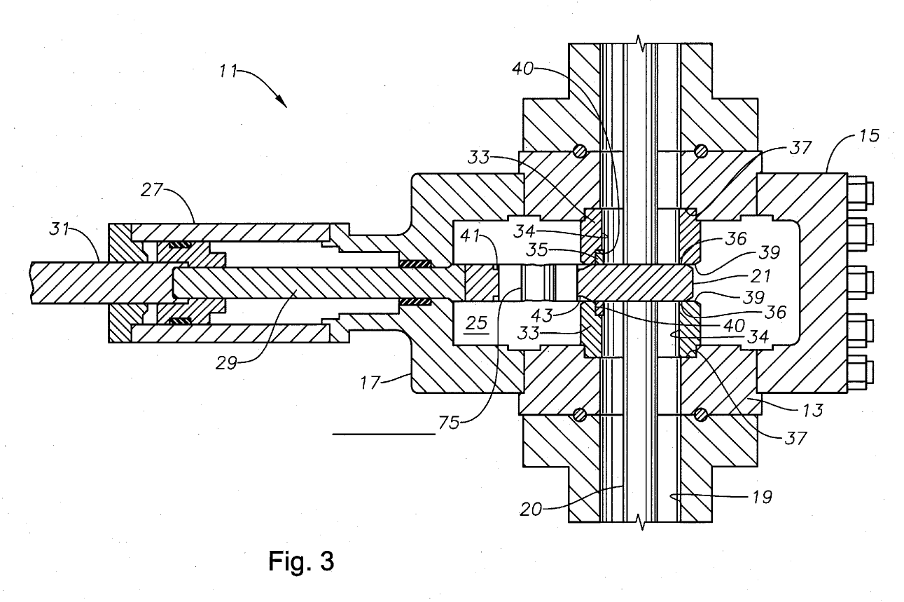

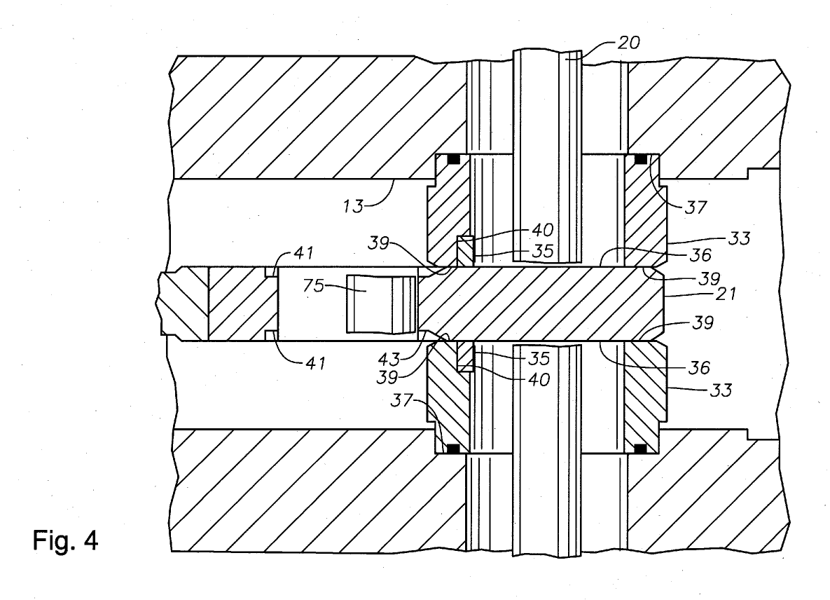

When the gate 21 is in the open position (FIGS. 1 and 2), the hole 23 of the gate 21 registers with the flow passage 19 of the valve 11, thereby allowing flow through the valve 11. When the gate 21 is closed (FIGS. 3 and 4), the hole 23 no longer registers with the flow passage 19. Instead, the solid portion 36 of the gate 21 registers with the flow passage 19 and comes into contact with the seats 33.

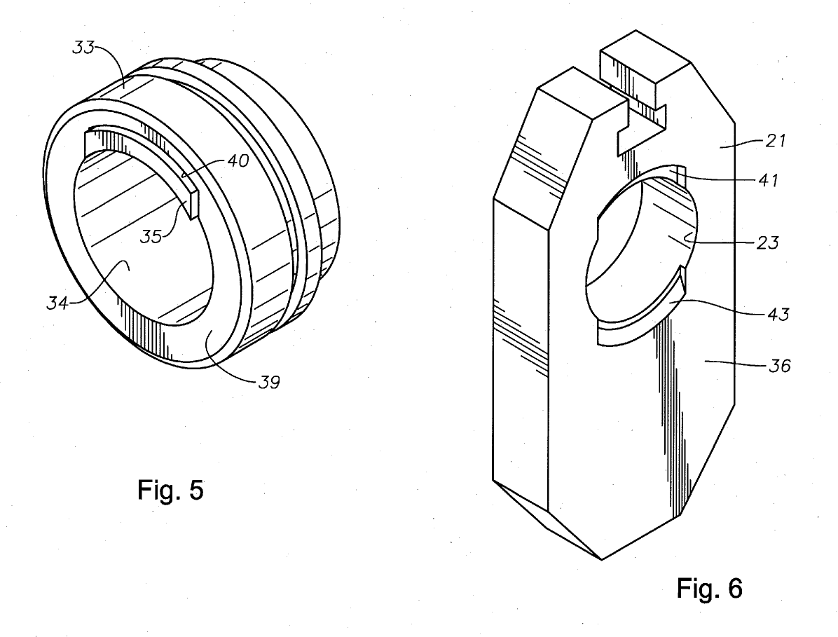

Referring to FIGS. 2 and 4, each seat 33 rests in a recess 37 formed in the valve body 13. Each seat 33 has a flat sealing face 39 that interfaces with the gate 21 when the gate 21 is in the closed position to create a seal. The sealing face 39 is located outboard of the shear elements 35. Each shear element 35 rests in a profile 40 on each valve seat 33 and projects beyond the face 39 of each seat 33 when in an extended position. The profile 40 appears on only one side of the hole 34, as illustrated in FIG. 5. The upper and lower sides of the gate 21 are profiled with arcuate recesses 41 such that when the gate 21 is in the open position, the gate 21 does not contact the shear elements 35. The upper and lower sides of the gate 21 have acutely angled surfaces 43 on their closing sides that are adapted to contact the shear elements 35 and force them apart axially relative to the axis of the valve seat hole 34 when the gate 21 is moved from an open position as illustrated in FIGS. 1 and 2 to a closed position as illustrated in FIGS. 3 and 4. FIG. 5 further illustrates the valve seat 33 having a hole 34 extending therethrough and the shear element 35 resting in the profile 40 and projecting beyond the sealing face 39 as it is shown in the extended position. The outer edges of the valve seat 33, outboard of the sealing face 39, are tapered. FIG. 6 further illustrates the gate 21 with the hole 23 extending therethrough and the recess 41 and acutely angled surface 43 opposite one another with the solid or main sealing portion 36 being adjacent to the hole 23. The recesses 41 are not annular and in the illustrated embodiment, extend only about forty-five (45) degrees.

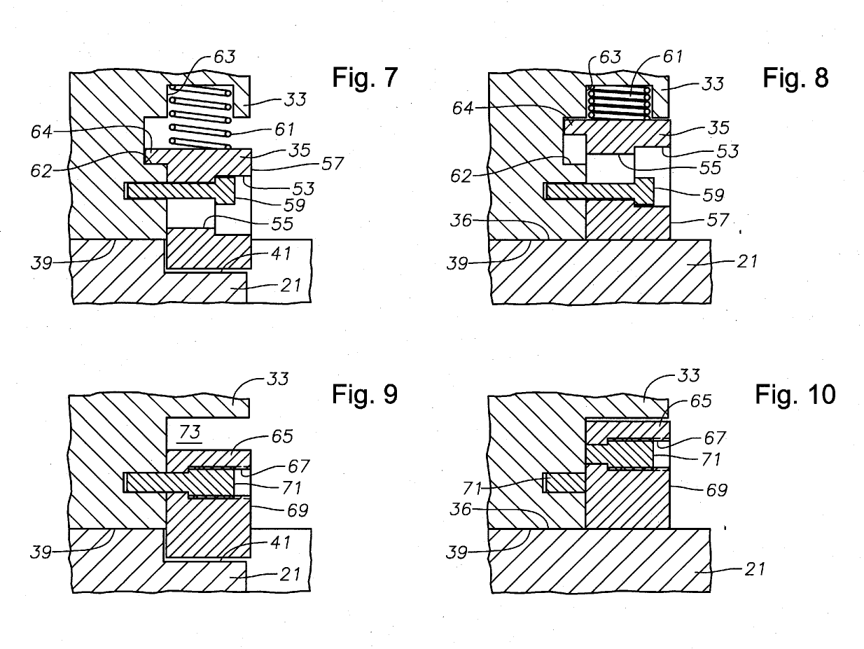

As previously mentioned, the shear elements 35 may be either rigidly or flexibly connected to the valve seats 33. In an embodiment illustrated in FIGS. 7 and 8, the shear elements 35 are flexibly connected to the valve seats 33. While the upper and lower shear elements 35 operate in the same manner, only the operation of the upper shear element 35 will be discussed for illustration purposes. The shear element 35 has a window 53 and an elongated aperture 55 extending through an inner surface 57. A retaining screw 59 passes through the window 53 and the aperture 55 in the shear element 35 and into the valve seat 33, thereby connecting the shear element 35 to the valve seat 33. The window 53 and the aperture 55 allow the shear element 35 to move relative to the retaining screw 59 and the valve seat 33. A resilient member 61 extends between the shear element 35 and the valve seat 33 and acts to bias the shear element 35 in an extended position relative to the valve seat 33. In an embodiment, the resilient member 61 is a spring that is positioned in a recessed pocket 63 of the valve seat 33. In other embodiments, the resilient member 61 may be an insert made from an elastic material. An upward facing shoulder 62 is formed in the valve seat 33. A stop tab 64 extends radially outward from the shear element 35 and is adapted to engage the upward facing shoulder 62 to limit the travel of the shear element 35 relative to the axis of the valve seat hole 34. As illustrated, the shear element 35 moves axially relative to the axis of the valve seat hole 34 beyond the sealing face 39 of the valve seat 33 as the spring 61 biases the shear element 35 to an extended position (FIG. 7). The profiles 41 in the gate 21 are such that the shear elements 35 do not contact the gate 21 in their extended position. In the extended position, the shear elements 35 are closer to each other than in the retracted position. However, the shear elements 35 do not contact the sealing surfaces of the gate 21 while in the extended position and the gate 21 is in the open position. While the gate 21 is being closed and moving from the open position to the closed position, the angled surfaces 43 push the shear elements 35 to the retracted position.

In an embodiment illustrated in FIGS. 9 and 10, shear elements 65 are rigidly, but releasably connected to the valve seat 33. While the upper and lower shear elements 65 operate in the same manner, only the operation of the upper shear element 65 will be discussed for illustration purposes. The shear element 65 has an aperture 67 extending through an inner surface 69. A shear pin 71 passes through the aperture 67 in the shear element 65 and into the valve seat 33, thereby rigidly connecting the shear element 65 to the valve seat 33. A void 73 exists between the shear element 65 and the valve seat 33 when the gate 21 is in the open position (FIG. 9), and allows for the shear element 65 to move axially relative to the axis of the valve seat hole 34 when the gate 21 is moved to a closed position (FIG. 10), thereby shearing the shear pin 71. As illustrated, the shear element 65 projects beyond the flat sealing face 39 of the valve seat 33 when the gate 21 is in an open position. The profile 41 in the gate 21 is such that the shear element 65 does not contact the gate 21 when the gate 21 is in an open position.

In operation, while in the open position shown in FIG. 1, fluid flows unrestricted through the flow passage 19. As further illustrated, in an embodiment, tubing 20 extends through the flow passage 19 unrestricted. In the closed position shown in FIG. 4, the downstream side of the gate 21 will seal against the sealing face 39 of the downstream valve seat 33.

In the event of an emergency situation, closure of the valve 11 may be required when downhole tooling such as coiled tubing or wireline are still running through the valve 11. When the valve 11 is required to prevent the flow of fluid, the actuation device 27 strokes the stem 29, which in turn strokes the gate 21 in a direction transverse to the flow passage 19, from an open position to a closed position. The side of the gate passage 23, opposite the shear elements 35, pushes the tubing 20 laterally into contact with the extended shear elements 35.

As the gate 21 moves from the open position shown in FIGS. 1 and 2 to the closed position shown in FIGS. 3 and 4, shear elements 35 will shear tubing 20, and then, as the gate 21 approaches the fully closed position, the acutely angled surfaces 43 on either side of the gate 21 contact the shear elements 35 and force the shear elements 35 apart, along the axis of the flow passage 19. The sealing faces on the solid portion 36 of the gate 21 interface directly with the sealing faces 39 on the either valve seat 33. As the hole 23 in the gate 21 no longer aligns with the holes 34 in the valve seats 33, the flow of fluid is restricted and a pressure differential across the gate 21 is created, which in turn creates a sealing contact stress between the sealing face 36 on the gate 21 and the sealing face 39 on the valve seat 33.

In further explanation and with respect to the embodiment illustrated in FIGS. 7 and 8, as the gate 21 approaches the fully closed position after shearing tubing 20, the acutely angled surfaces 43 on either side of the gate 21 contact the shear elements 35. While the upper and lower shear elements 35 operate in the same manner, only the operation of the upper shear element 35 will be discussed for illustration purposes. The angled surface 43 contacts the shear element 35 and causes the shear element 35 to move upward relative to the valve seat 33. The force the gate 21 applies to the shear element 35 causes the resilient member 61 to compress and for the shear element 35 to move upward to such point that the retaining screw 59 is positioned in the bottom of the window 53 and elongated aperture 35. The ability of the shear element 35 to move axially upward relative to the valve seat 33 allows the gate 21 to shear the tubing 20 on the thinner profiled section on the hole 23, but to seal on the main solid section 36 of the gate 21. As a result, the shear element 35 shears, but is not involved in the sealing. This technique also produces a plug of tubing 75 (FIG. 4) that is shorter than the gap between the opposing sealing faces 39 on the two valve seats 33 such that there is no interference between the tubing plug 75 and the valve seats 33 that may cause further/additional surface damage to the valve seats 33.

With respect to the embodiment illustrated in FIGS. 9 and 10, as the gate 21 approaches the fully closed position after shearing tubing 20, the acutely angled surfaces 43 on either side of the gate 21 contact the shear elements 65. While the upper and lower shear elements 65 operate in the same manner, only the operation of the upper shear element 65 will be discussed for illustration purposes. The angled surface 43 contacts the shear element 65 and causes the upper shear element 65 to move axially upward relative to the valve seat 33. The force the gate 21 applies to the shear element 65 causes the shear pin 71 to shear, which allows the shear element 65 to move upward to fill the void 73 between the shear element 65 and the valve seat 33. The ability of the shear element 65 to move axially upward relative to the valve seat 33 allows the gate 21 to shear the tubing 20 on the thinner profiled section around the hole 23, but to seal on the main solid section 36 of the gate 21. As a result, the shear element 65 shears, but is not involved in the sealing. This technique also produces a plug of tubing 75 (FIG. 4) that is shorter than the gap between the opposing sealing faces 39 on the two valve seats 33 such that there is no interference between the tubing plug 75 and the valve seats 33 that may cause further/additional surface damage to the valve seats 33.

In the drawings and specification, there have been disclosed a typical preferred embodiment of the technique, and although specific terms are employed, the terms are used in a descriptive sense only and not for purposes of limitation. The technique has been described in considerable detail with specific reference to these illustrated embodiments. It will be apparent, however, that various modifications and changes can be made within the spirit and scope of the technique as described in the foregoing specification and as set forth in the following claims.

1. A gate valve comprising:
a valve body having an flow passage and a central chamber therein;
a gate having a hole therein, the gate being linearly movable within the chamber between a closed position blocking flow through the flow passage and an open position in which the hole registers with the flow passage;
first and second valve seats mounted in the chamber on opposite sides of the gate at intersections of the flow passage with the central chamber, the valve seats having sealing surfaces that engage the gate when the gate is in the closed position; and
a shear element connected to and carried by at least one of the valve seats, the shear element being capable of movement relative to the at least one of the valve seats in response to movement of the gate from the open position to the closed position.

2. The gate valve of claim 1 wherein each of the valve seats has a shear element.

3. The gate valve of claim 1 further comprising: a resilient member constrained between said at least one of the valves seats and the shear element that biases the shear element in an extended position, protruding beyond the sealing surface of said at least one of the valve seats when the gate is in the open position.

4. The gate valve of claim 1 further comprising: a shear pin extending through the shear element and connected to said at least one of the valve seats to maintain the position of the shear element in an extended position, protruding beyond the sealing surface of said at least one of the valve seats when the gate is in the open position, the shear pin being adapted to shear and allow movement of the shear element relative to said at least one of the seat valves when the gate is moved from the open position to the closed position.

5. The gate valve of claim 1 in which the gate has an angled surface that engages the shear element as the gate moves from the open position to the closed position, thereby forcing the shear element to move relative to said at least one of the valve seats to a retracted position.

6. The gate valve of claim 1 further comprising: a resilient member in said at least one of the valve seats adapted to maintain the shear element in an extended position while the gate is in the open position.

7. The gate valve of claim 1 wherein the shear element is a partial segment of a circle.

8. The gate valve of claim 1 further comprising: a retainer in said at least one of the valve seats that limits the projection of the shear element in an extended position.

9. The gate valve of claim 1 wherein movement of the shear element is axial relative to an axis of the hole in the gate.

10. A gate valve comprising:
a valve body having a flow passage and a central chamber therein;
a gate having a hole therein, the gate being linearly movable within the chamber between a closed position blocking flow through the flow passage and an open position in which the hole registers with the flow passage;
first and second valve seats mounted in the chamber on opposite sides of the gate at intersections of the flow passage with the central chamber, the valve seats having sealing surfaces that engage the gate when the gate is in the closed position; and
a shear element that is a partial segment of a circle connected to and carried by each of the valve seats, the shear elements protruding beyond the sealing surfaces of the valve seats in an extended position when the gate is in the closed position and being capable of axial movement relative to an axis of the hole in the gate to a retracted position in response to movement of the gate from the open position to the closed position.

11. The gate valve of claim 10 in which the hole in the gate has angled surfaces that engage the shear elements as the gate moves from the open position to the closed position, thereby forcing the shear elements from the extended position to the retracted position.

12. The gate valve of claim 10 further comprising: a resilient member constrained between each of the valves seats and each of the shear elements that biases each of the shear elements in the extended position when the gate is in the open position.

13. The gate valve of claim 10 further comprising: a shear pin extending through each shear element and connected to each valve seat to maintain the position of the shear elements in the extended position when the gate is in the open position, the shear pins being adapted to shear and allow movement of the shear elements relative to the valve seats to a retracted position when the gate is moved from the open position to the closed position.

14. The gate valve of claim 10 further comprising: a retainer in each of the seat valves that limits the projection of the shear elements in an extended position.

15. The gate valve of claim 10 further comprising: a resilient member constrained between each of the valves seats and the shear elements that biases the shear elements in an extended position, protruding beyond the sealing surfaces of the valve seats when the gate is in the open position; and
a fastener that extends through an elongated aperture in each of the shear elements and movably connects the shear elements to the valve seats, thereby allowing the shear elements to move from an extended position to a retracted position.

16. A method of sealing a flow path comprising:
(a) mounting a gate within a valve body having valve seats, a central chamber and a flow passage extending therefrom, the gate having a hole therein; mounting a shear element to at least one of the valve seats with the shear element in an extended position;
(b) moving the gate from an open position toward a closed position, which causes the shear element to move to a retracted position; and
(c) engaging the gate with the valve seats, thereby sealing the flow passage.

17. The method according to claim 16, wherein step (b) further comprises:
engaging the gate with downhole tooling as the gate moves from the open position toward the closed position, thereby engaging the downhole tooling with the shear element and shearing the downhole tooling.

18. The method according to claim 16, wherein the movement of the shear element to the retracted position is axial relative to an axis of the hole in the gate.

19. The method according to claim 16, wherein step (a) further comprises:
biasing the shear element to the extended position.

20. The method according to claim 16, wherein step (a) further comprises fixing the shear element in the extended position with a shearable member; and
wherein step (b) further comprises shearing the shearable member.
